(19) United States
(12) Patent Application Publication
(10) Pub. No.: US 2022/0245874 A1
(43) Pub. Date: Aug. 4, 2022

(54) METHOD OF CONVERTING AND REPLAYING STYLES OF VECTOR IMAGES

(71) Applicant: BK LTD., Gyeongsangbuk-Do (KR)

(72) Inventor: Jae Hyun Bahk, Gyeongsangbuk-do (KR)

(21) Appl. No.: 17/587,809

(22) Filed: Jan. 28, 2022

(30) Foreign Application Priority Data
Feb. 4, 2021 (KR) 10-2021-0016347

(51) Int. Cl. G06T 11/60; G06T 11/40; G06T 11/20; G06F 3/0354

(52) U.S. Cl. CPC G06T 11/60; G06F 3/03545; G06T 11/203; G06T 11/40

(57) ABSTRACT

A method of converting and replaying styles of vector images. The method includes: generating a first original completed image from a vector original image; generating a second style conversion completed image whose styles are converted to styles of another artist's famous art work for style conversion; extracting line information of the second style conversion completed image matching coordinate values of vector lines selected by a user from the vector original image with reference to the second style conversion completed image; changing information of the selected vector lines and displaying the information to the user; and preparing a configuration including a step of generating a new vector image whose style is converted to show a style conversion process in real time, as if a real artist were painting, thereby being able to provide many effects to the user to appreciate and learn to draw pictures.

### CROSS REFERENCE TO RELATED APPLICATION

The present application claims priority to Korean Patent Application No. 10-2021-0016347, filed Feb. 4, 2021, the entire contents of which is incorporated herein for all purposes by this reference.

### BACKGROUND OF THE INVENTION

### Field of the Invention

The present disclosure relates to a method of converting and replaying styles of vector images and, more particularly, to a method of converting and replaying styles of vector images drawn in a vector method using a mobile device, a tablet PC, or a computer terminal.

### Description of the Related Art

Computer graphics methods are largely divided into a bitmap method and a vector method.

FIGS. 1 and 2 are views respectively illustrating processes of drawing pictures or text in a mobile device.

In FIG. 1, a process of drawing a picture in the bitmap method is illustrated, and in FIG. 2, a process of drawing a picture in the vector method is illustrated.

In the related art, when drawing a picture or text on a screen by using a mobile device, as shown in FIG. 1, the bitmap method is used.

Since the bitmap method includes only color information per pixel, only a color may be changed for each pixel when a user desires to perform correction or modification later.

Accordingly, a method for vector graphics has been developed, wherein a drawn picture and text include line information rather than color information for each pixel so that the drawn picture and text is modifiable.

The vector graphics refers to a method in which objects such as points, straight lines, curves, and polygons based on mathematical equations are used when displaying a picture in computer science.

The vector graphics technology is a method in which an electron beam continuously moves along a line segment or curve appearing on a graphic screen to display an image on the screen, and there is an advantage of being convenient to process the line drawings and having high resolution.

That is, vector graphics creates a digital image through a series of instructions or mathematical expressions in order to arrange lines or shapes in a given two-dimensional or three-dimensional space.

A vector in physics refers to an object having both a quantity and a direction at the same time.

Meanwhile, in the vector graphics, graphic files that are the results of creative activities of artists are generated and stored in the format of a series of vector declarative sentences. For example, in order to draw a line, a vector graphics file stores locations of a series of points to be connected to each other, instead of storing each of bits. Accordingly, the vector graphics file results in making a file size smaller than that of the related art.

That is, as shown in FIG. 2, the vector method includes information (hereinafter abbreviated as “vector line information”) such as work sequence indices of vector lines, coordinate values stored in a line, line thicknesses, line colors, line shapes, types of pens used to draw an image, types of brushes used, transparency of the line, and pen pressure indicating pressure with which the pens are pressed.

Accordingly, in the vector method, each stroke sequentially stored for each work step may be recalled to redraw or modify a stroke.

Meanwhile, recently, with the development of artificial intelligence (AI) and digital image processing technology, programs or applications for converting image styles with the styles of famous paintings or masterpieces are being developed.

Accordingly, as shown in FIGS. 3A to 3E, techniques of converting styles of pictures into the styles of famous artists such as Gogh, Gauguin, Munch, Leonardo da Vinci, Picasso, Klimt, and various webtoon authors by applying a painting style conversion technique using artificial intelligence are in vogue.

FIGS. 3A to 3E are views illustrating the painting style conversion technique.

FIG. 3A is a view illustrating an original image, FIG. 3B is a view illustrating an image of a famous artist, and FIG. 3C is a view illustrating a result of converting a style of the original image shown in FIG. 3A into a style of the artist shown in FIG. 3B.

In addition, an original image is shown in FIG. 3D, and results converted with various styles are illustrated in FIG. 3E.

The Korean Patent No. 10-1189033 discloses technology for converting an image file to be suitable for output on a mobile device, and the Korean Patent No. 10-2073388 discloses technology for providing an image by applying an artist's style to the image.

The Korean Patent No. 10-1189033 describes a configuration for converting a cartoon content image file into an image file for mobile use, and the Korean Patent No. 10-2073388 describes a configuration for applying, in a server, an artist's style to an image received from an artist client so as to create and provide tracing images.

### SUMMARY OF THE INVENTION

As described above, since a bitmap is a format in a final rendered state, image editing is not free, and as the resolution of the bitmap is fixed, when performing up-scaling, image quality is greatly damaged, and even in a case of performing down-scaling or rotation, anti-aliasing operations are applied redundantly, so the image quality may be greatly damaged.

However, as the painting style conversion technique according to the related art converts styles of pictures drawn in the bitmap method, only an original picture and a final result of style conversion are provided as shown in FIGS. 4A and 4B.

FIGS. 4A and 4B are views illustrating the pictures drawn in the bitmap method and the final style-converted image, wherein the original image of the picture is illustrated in FIG. 4A, and the final style-converted result is illustrated in FIG. 4B.

As described above, a painting style conversion method according to the conventional bitmap technique provides only a final result obtained by converting styles of a picture drawn in the bitmap method, so the method is unable to convert the styles from the first step to the last step in the work.

That is, the painting style conversion technique does not simply change colors, but recognizes an artist's style and colors in an entire picture, and changes a picture according to the recognized style, and thus style conversion is possible only when the picture is mostly completed.

Therefore, the quality of style conversion result is inevitably deteriorated until a drawing work reveals an outline of a certain shape.

As described above, in the painting style conversion method according to the conventional bitmap technique, an intermediate process of style conversion work is unable to be known, and even when a user attempts to convert pictures in the intermediate process, the user is unable to know which picture is being drawn in an image of the intermediate process, whereby there is a problem in that the result of the style conversion becomes inaccurate.

An objective of the present disclosure is to solve the above problems and to provide a method of converting and replaying styles of vector images, wherein images such as pictures or text drawn in the vector method may be converted with the desired styles, and the style-converted vector image may be replayed.

In order to achieve the above objective, a method of converting styles of vector images according to the present disclosure includes: (a) extracting a first original completed image from a vector original image at a final step or at each work step selected by a user; (b) converting styles of the first original completed image into styles of another art work to create a second style conversion completed image; (c) receiving vector lines, whose styles are to be converted, selected from among vector lines included in the vector original image, and determining a sequence of style conversion of the selected vector lines; (d) extracting coordinate values for each of the vector lines selected in step (c), generating line information from lines at the same position as those of coordinate values extracted from the second style conversion completed image, performing the style conversion by changing the vector line information included in the vector original image to generate the line information, and changing the sequence of the style conversion and style replay; and (e) finally creating a new vector image by displaying step by step a style conversion process of the vector original image according to user's settings in step (d) and replaying the style conversion process by imitating a moving picture, or finally creating the new vector image by collectively changing the style conversion process without displaying the style conversion process.

As described above, according to the method of converting and replaying the styles of the vector images according to the present disclosure, the method of converting and replaying the styles of the vector images provides a way to break away from the conventional method of performing style conversion for only a fragmentary final version of the conventional bitmap method, so as to display a style conversion process of the vector images in real time, as if a real artist were painting a picture, whereby there is an effect of providing much effectiveness for users to appreciate and learn to draw a picture.

### BRIEF DESCRIPTION OF THE DRAWINGS

FIGS. 1 and 2 are views respectively illustrating processes of drawing pictures or text on a mobile device.

FIGS. 3A to 3E are views illustrating a painting style conversion technique for pictures.

FIGS. 4A and 4B are views illustrating a picture drawn in the bitmap method and a final style-converted image.

FIGS. 5A to 5E are views illustrating an entire style conversion process of vector images.

FIGS. 6A and 6B are views illustrating work processes of the bitmap method and the vector method.

FIG. 7 is a view illustrating a work process for drawing a picture in the vector method.

FIG. 8 is a view describing the style conversion process step by step for an image of the conventional vector method.

FIG. 9 is a view illustrating the style conversion process using colors and information of a style-converted line from a first step of drawing with reference to a final style-converted image.

FIGS. 10A to 10D are views illustrating the style conversion process for each coordinate value.

FIG. 11 is a view illustrating a process of converting and replaying all strokes.

FIGS. 12A to 12D are views illustrating the style conversion process of an image according to the present disclosure.

FIGS. 13A to 13C are views illustrating the style conversion process by changing a picture to have the same resolution and same positions when resolution of an original image and resolution of a style-converted image for reference are different from each other.

FIGS. 14A to 14C are views illustrating the style conversion process performed by designating an area whose styles are to be converted.

FIGS. 15A to 15D are views illustrating a process of selecting and converting one or more areas whose styles are to be converted.

FIGS. 16A to 16C are views illustrating a state in which styles of vector lines in contact with a stroke unit selection line are converted.

FIGS. 17A to 17C are views illustrating a state of staged style conversion of each vector line using a vector image.

FIG. 18 is a view illustrating a process of replaying the style conversion process of specific color regions selected by a user in an image drawn in the vector method.

FIGS. 19A to 19C are views illustrating a process of receiving specific colors selected by the user and replaying the style conversion process in a different sequence for each of the selected colors.

FIG. 20 is a view exemplifying a process of receiving a selection of a specific area from the user and converting styles of the selected area.

FIG. 21 is a flowchart describing step by step the method of converting and replaying styles of vector images according to the preferred exemplary embodiment of the present disclosure.

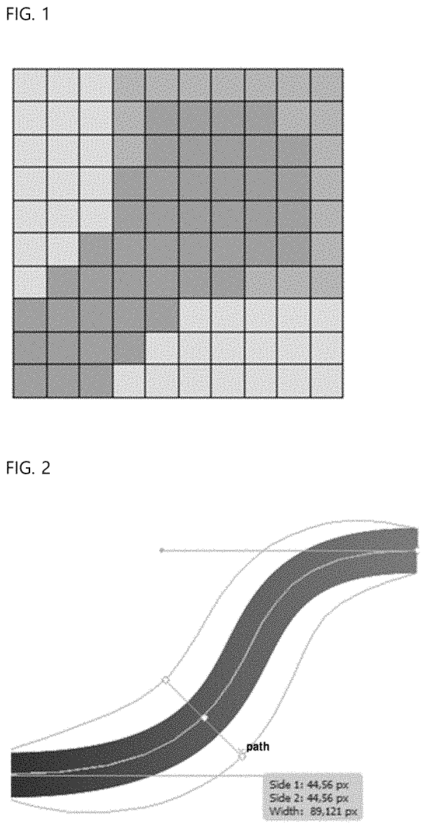

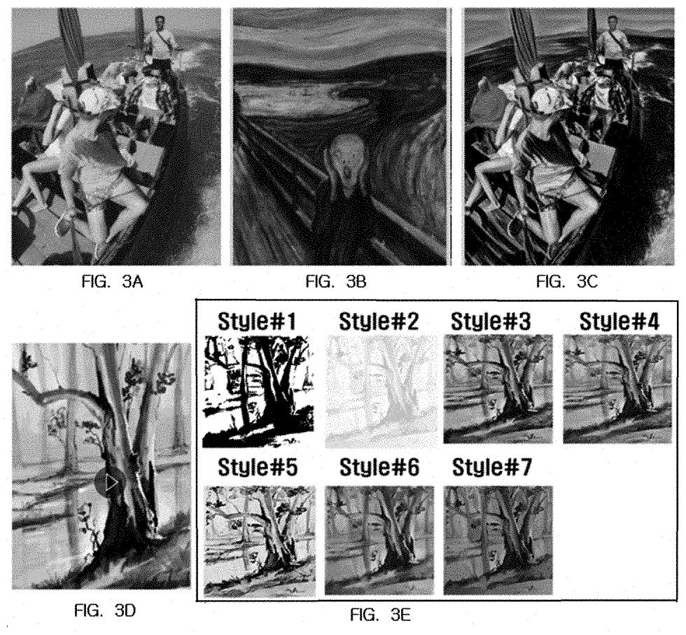

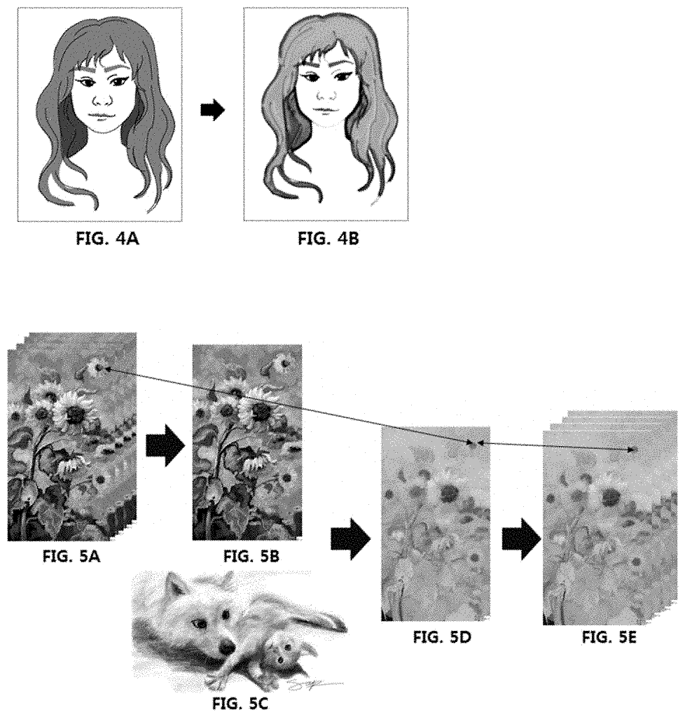

### DETAILED DESCRIPTION OF THE INVENTION

Hereinafter, a method of converting and replaying styles of vector images according to a preferred exemplary embodiment of the present disclosure will be described in detail with reference to the accompanying drawings.

The embodiment of the present disclosure converts and replays styles of images drawn in the vector method by using a mobile device, a tablet PC, or a computer terminal (hereinafter abbreviated as “mobile device”), that is, the styles of the images stored in the mobile device.

In particular, the embodiment of the present disclosure receives a user-selected work step of a vector image for drawing a picture or text, and changes a sequence of selected vector lines, so as to perform style conversion in stages.

At each work step of the image stored in the vector method, the embodiment of the present disclosure converts only the vector lines selected by the user or converts the styles in the sequence desired by the user, so as to replay the style conversion process step by step by imitating a moving picture.

The method of converting and replaying the styles of the vector images according to the preferred exemplary embodiment of the present disclosure may operate in mobile devices, tablet PCs, computer terminals, and the like, which have been activated by downloaded programs or applications so as to control operations of the mobile devices, tablet PCs, computer terminals, and the like or to perform the method of style conversion and style replay.

For example, although not shown in the drawings, the mobile device may include: a display part configured to display images such as pictures or text on a screen; an input part configured to receive input of a user's operation instruction; a program or application configured to drive the mobile device; a storage part configured to store information of the image drawn in the vector method and input information input by the user; and a controller configured to control driving of each device.

Here, the display part and the input part may be integrated into a touch screen to increase user's operation convenience.

The controller may execute the program or application to store information of images drawn in the vector method, change colors or sizes according to a user's operation, and control to replay the images by changing a playback sequence.

Accordingly, the method of converting styles of vector images according to the present disclosure includes: (a) extracting a first original completed image from a vector original image at a final step or at each work step selected by a user; (b) converting styles of the first original completed image into styles of another art work to create a second style conversion completed image; (c) receiving vector lines, whose styles are to be converted, selected from among vector lines included in the vector original image, and determining a sequence of style conversion of the selected vector lines; (d) extracting coordinate values for each of the vector lines selected in step (c), generating line information from lines at the same position as those of coordinate values extracted from the second style conversion completed image, performing the style conversion by changing the vector line information included in the vector original image to generate line information, and changing the sequence of the style conversion and style replay; and (e) finally creating a new vector image by displaying step by step a style conversion process of the vector original image according to user's settings in step (d) and replaying the style conversion process by imitating a moving picture, or finally creating the new vector image by collectively changing the style conversion process without displaying the style conversion process.

That is, the embodiment of the present disclosure is configured to receive, from a user, vector lines whose styles are to be converted in a vector original image, perform style conversion by setting a style conversion sequence of the selected vector lines, change original colors to style-converted colors, and change an original work sequence to a work sequence set by the user, so as to create a new vector original image and quickly display the style conversion process of the vector lines selected by the user, whereby the style conversion process may be displayed as if a moving picture were replayed.

FIGS. 5A to 5E are views illustrating the entire style conversion process of vector images according to the present disclosure.

In FIGS. 5A to 5E, a vector original image is illustrated. In FIG. 5B, a first original completed image created by using the image shown in FIG. 5A is illustrated. In FIG. 5C, an image of another artist's art work for style conversion is illustrated. In FIG. 5D, a second style conversion completed image created from the first original completed image shown in FIG. 5B by referring to another artist's image shown in FIG. 5C is illustrated. In addition, in FIG. 5E, a new vector image is illustrated, whose styles are finally converted by extracting new style-converted line information through matching coordinate values of the vector original image shown in FIG. 5A and coordinate values of the second style conversion completed image shown in FIG. 5D and by changing colors of the vector lines and the information on the vector lines included in the vector original image shown in FIG. 5A.

That is, as shown in FIGS. 5A to 5E, in the method of converting the styles of the vector images according to the present disclosure, the first original completed image FIG. 5B is created by using the vector original image shown in FIG. 5A, the second style conversion completed image is created by referring to the image of another art work for style conversion shown in FIG. 5C from the first original completed image, and the information on the style-converted vector lines is extracted by matching the coordinate values of the vector original image and the coordinate values of the second style conversion completed image, so that the vector lines of the vector original image are changed to have the vector line information such as the colors, thicknesses, and pen pressure of each line, whereby a new vector image, as shown in FIG. 5E, whose styles are finally converted may be created.

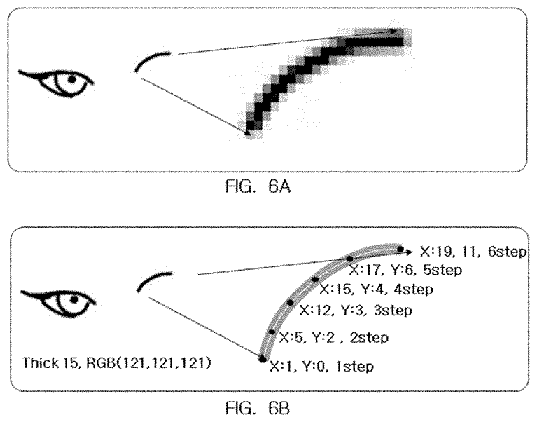

FIGS. 6A and 6B are views illustrating a work process for drawing a picture in the vector method.

The bitmap method stores only color information per pixel as shown in FIG. 6A.

Whereas, the vector method stores various pieces of pen information such as line lengths, thicknesses, colors, coordinate values, work sequences, pen types, patterns, and pen pressure, as shown in FIG. 6B.

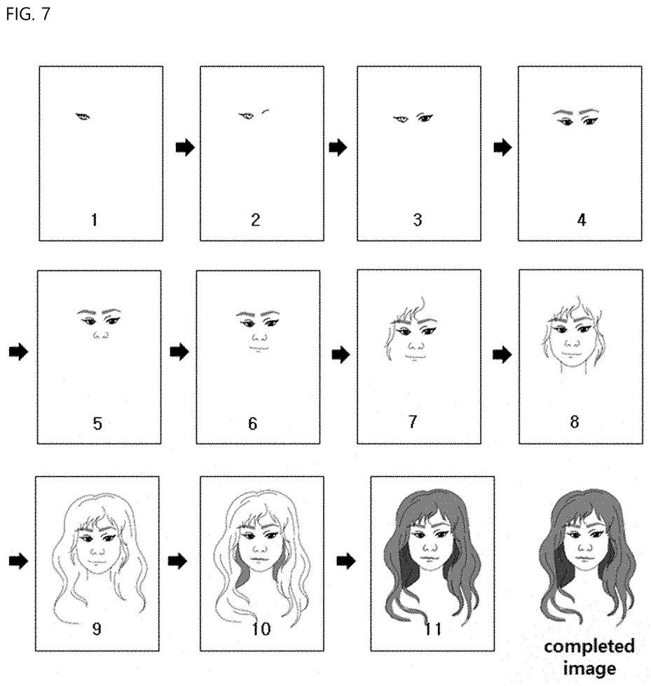

FIG. 7 is a view illustrating a work process of drawing a picture in the vector method.

In the vector method, as shown in FIG. 7, all strokes of a picture are drawn sequentially for each predetermined step.

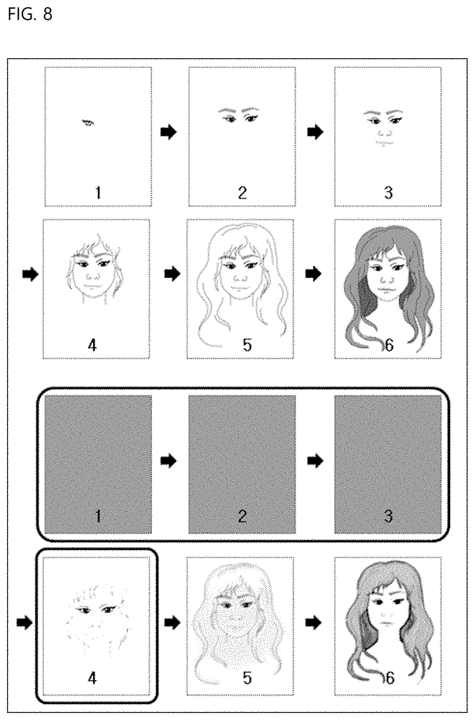

FIG. 8 is a view describing a process of performing style conversion of an image of the conventional vector method step by step.

As described above, in the conventional bitmap method, styles of only the final version of an image may be converted. In addition, in the conventional vector method, style conversion may be performed step by step, but only when a user is able to recognize what image it is, the style conversion is possible.

That is, in steps 1 to 3 shown in FIG. 8, since it is not known what image it is, performing style conversion is impossible, and in step 4, although it is shown that the style conversion is performed, the quality thereof is much deteriorated.

In addition, the bitmap method has no intermediate step in the drawing work, but only has the final version of a picture, and thus how style conversion is performed is unable to be figured out when performing the style conversion. Even in the conventional vector method, even though style conversion is performed by storing a separate image for each work process, the style conversion is performed to some extent only when about 40% to about 70% or more work revealing an outline of the image is progressed.

Whereas, in the present disclosure, a color matching a coordinate value of each line whose styles are to be converted is converted step by step by extracting information on vector lines arranged at the same position in the final version of an image.

That is, in the present exemplary embodiment, unlike the conventional bitmap method and conventional vector image method, the style conversion is performed in line units or for each step set by a user from the first step to the last step of drawing work.

To this end, the embodiment of the present disclosure first performs style conversion of a final result of an image, and in the final result whose styles are converted, coordinates of each stroke of each intermediate step of the work process is respectively compared with positions of the final result, so that colors are extracted and each stroke may be changed step by step using the extracted vector line information.

Here, the information of the vector lines refers to vector line information such as a work sequence index indicating which line was first worked, coordinate values stored in the line, line thicknesses, line colors, line patterns, types of pens used, types of brushes used, transparency of the line, and pressure of the pens.

The embodiment of the present disclosure selects a specific color or a specific area, performs style conversion for selected vector lines, and changes a sequence to create a new vector image.

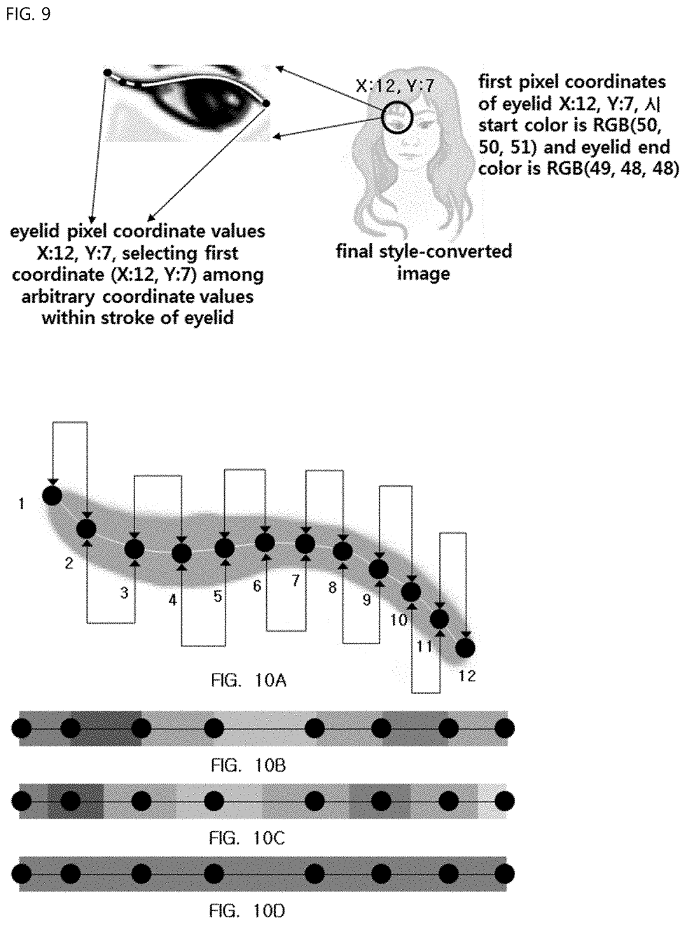

FIG. 9 is a view describing a method of replaying an image stored in the conventional vector method, wherein the style conversion process using colors and information of a style-converted line from a first step of drawing with reference to a final style-converted image is illustrated. FIGS. 10A to 10D are views illustrating the style conversion process for each coordinate value.

In FIG. 9, a process with steps is illustrated, the steps including: creating a first original completed image from a vector original image; creating a second style conversion completed image by referring to another famous art work whose style is for style conversion; extracting coordinate values of the eyelids of the thus-created second style conversion completed image and vector original image; generating information of vector lines corresponding to the extracted eyelid coordinate values from the second style conversion completed image; and performing the style conversion for the eyelid vector lines of the vector original image.

As shown in FIG. 9, when drawing the eyelids of the final style-converted image, a user may read coordinate values of strokes of the eyelids and select which coordinate value from among these coordinate values to refer to as a reference for the style-converted image.

In FIGS. 10A to 10D, a state in which a single vector line is not converted with a style, but is converted with a style for each coordinate value thereof is illustrated.

That is, in FIGS. 10A and 10B, a state in which the single vector line is not converted with a style, but is converted with a style for each coordinate value is illustrated. In FIG. 100, a state in which style conversion is performed by dividing at the middle of each section between adjacent coordinate values is illustrated. In FIG. 10D, a state in which colors are respectively extracted from all coordinate values and the colors of the entire vector line are converted to a style by using an average value of the extracted colors.

The embodiment of the present disclosure is configured to calculate coordinate values for vector lines of the eyelids included in a vector original image in a step of currently drawing the eyelids, and from a second style conversion completed image completed by referring to an art work drawn by another famous artist, searches for the eyelids that match the calculated coordinate values, and extracts colors of the searched eyelids, so as to convert the colors of the eyelid vector lines of the vector original image, whereby the eyelids may be drawn.

Meanwhile, in FIG. 9, a state in which the styles are converted on the basis of first coordinate values is illustrated. That is, in FIG. 9, a process is illustrated, wherein the first coordinates of X:12 and Y:7, which are the first coordinate values among arbitrary coordinates, are selected from a vector line of an eyelid included in the vector original image to be drawn from now, and the colors of X:12, Y:7, which are the eyelid positions corresponding to the same coordinate values of the second style conversion completed image are extracted, thereby drawing an image.

Certainly, in the present disclosure, as shown in FIG. 10A, each color may be separately extracted for each coordinate value and changed to each color.

Meanwhile, as described above, in the present disclosure, in the process of creating a new style conversion vector image by sequentially performing the style conversion from the first vector line to the last vector line of the vector original image, the colors for the extracted coordinate values may be extracted and a unit for applying the extracted color may be applied to each coordinate value section, so as to perform style conversion by dividing the coordinate values present in a line of the vector original image rather than by a unit of the line as shown in FIG. 10B, and the styles for each coordinate value unit may be converted within one line rather than an entire line unit, the coordinate value unit being one section unit obtained by centers of adjacent coordinate values, as shown in FIG. 100, and further, the colors for all coordinate values may also be calculated and the style conversion may be performed for the vector line with a color of an average value for the calculated colors as shown in FIG. 10D.

In addition, in the present disclosure, the colors for all coordinate values in the vector line of the current work step may be extracted from the second style conversion completed image, and the colors may be extracted by calculating with any one filter value from among values of average, rounding off, and rounding down of all the extracted colors.

In addition, in the present disclosure, style conversion may be performed by selecting one or more colors or color regions selected by a user from among information on all the style-converted vector lines.

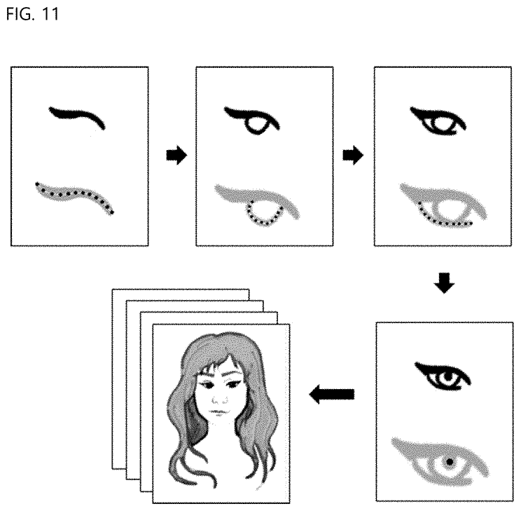

FIG. 11 is a view illustrating a process of converting and replaying all strokes.

The result obtained by extracting the colors from the style-converted image in which the remaining strokes for the eyes, iris, and face are processed in the same way as shown in FIG. 9 and changing the colors for each step is illustrated in FIG. 11.

Therefore, starting from the first step at the top of FIG. 7, the embodiment of the present disclosure uses a vector-type style conversion technique to draw a picture by using color information obtained from the final style-converted image, whereby the style may be accurately converted for each work step of each picture.

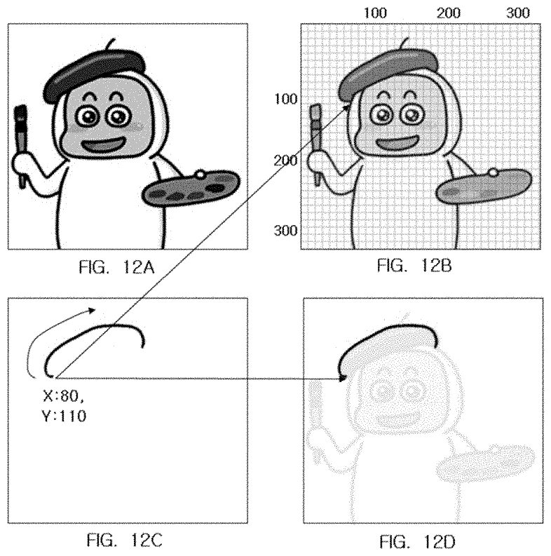

FIGS. 12A to 12D are views illustrating the style conversion process of an image according to the present disclosure.

In FIGS. 12A to 12D, a vector original image having a resolution of 330*310 before performing style conversion is illustrated, and in FIG. 12B, a bitmap converted to a soft color style at a resolution of 330*310 is illustrated. Here, the color of a bitmap having coordinates of X:80, Y:110 is RGB(41,41,41).

In FIG. 12C, the coordinate values of a vector line to be drawn first in the vector original image having the resolution of 330*310 are illustrated, and in FIG. 12D, a state in which the position of the first vector line is confirmed in the vector original image having the resolution of 330*310 is illustrated.

Certainly, even when the resolution are different, extraction may be possible through mathematical calculations as well, but it is preferable to perform conversion by using the same resolution.

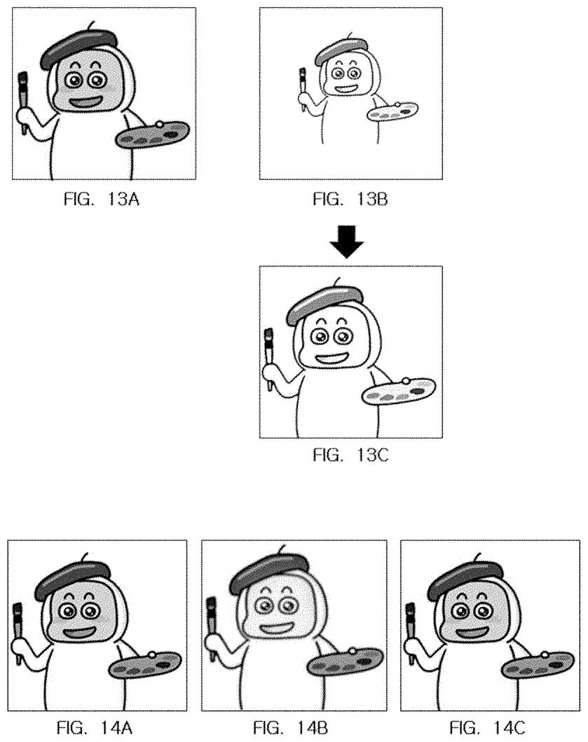

FIGS. 13A to 13C are views illustrating the style conversion process by changing a picture to have the same resolution and same positions when resolution of an original image and resolution of a style-converted image for reference are different from each other.

In FIG. 13A, a vector original image having a resolution of 330*310 is illustrated. In FIG. 13B, a style conversion completed image having a resolution of 110*103 is illustrated. In FIG. 13C, an enlarged image of the style conversion completed image to have a resolution of 330*310 is illustrated.

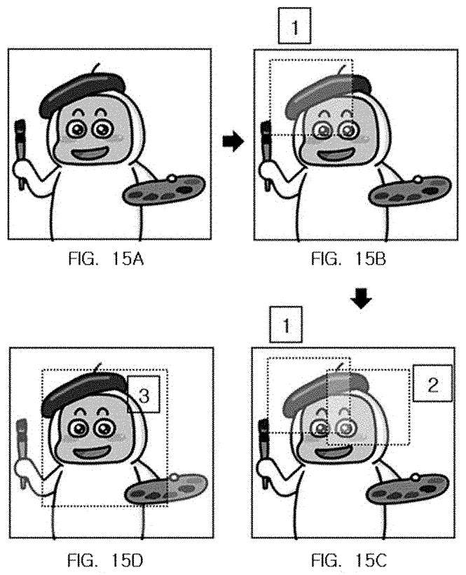

FIGS. 14A to 14C are views illustrating a process of style conversion performed by designating an area whose styles are to be converted. FIGS. 15A to 15D are views illustrating a process of selecting and converting one or more areas whose styles are to be converted.

In FIGS. 14A and 14B, a vector original image and a style-converted image are respectively illustrated. In FIG. 14C, a state is illustrated, wherein, in an area whose styles are to be converted by a user, that is, for example, an area of a face, eyes, and lips to which specific colors are selected and applied, the color styles thereof are converted.

In FIG. 15A, a vector original image is illustrated. In FIG. 15B, a state in which the first selection area designated by the user is converted with a style is illustrated. In addition, in FIG. 15C, a state in which styles of a plurality of areas, for example, the first and second selected areas, are converted is illustrated. In FIG. 15D, a state in which styles of the remaining areas excluding the selected areas are converted is illustrated.

As described above, in the present disclosure, one or more color regions whose styles are to be converted may be selected by the user, or a color may be selected so as to perform style conversion for only the selected color regions, or styles of only the remaining color regions excluding the selected color regions may be converted.

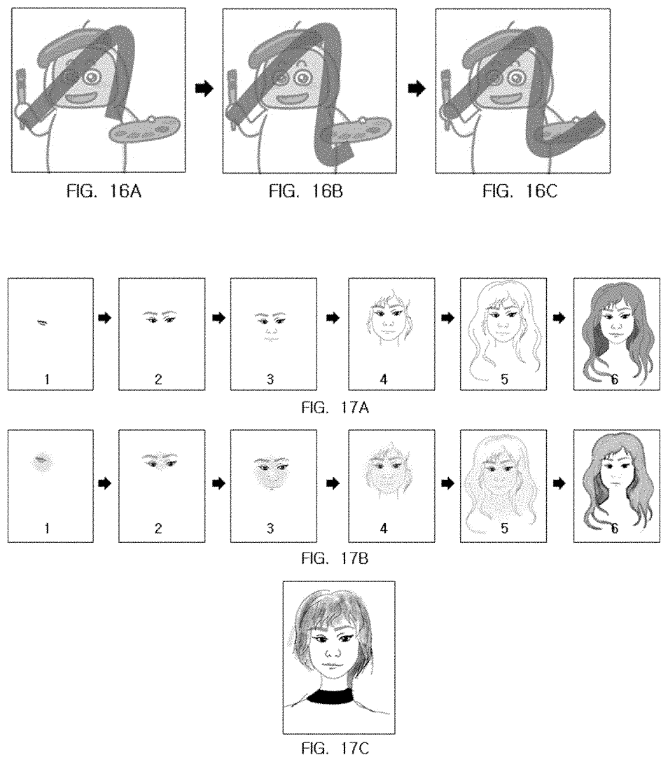

FIGS. 16A to 16C are views illustrating a state in which styles of vector lines in contact with a stroke unit selection line are converted. FIGS. 17A to 17C are views illustrating a state of staged style conversion of each vector line using a vector image.

In FIGS. 16A to 16C, states in which a stroke unit selection line is drawn so as to come into contact with the vector lines whose styles are to be converted, and the styles of the vector lines in contact with the stroke unit selection line are converted are illustrated.

In FIG. 17A, a vector original image is illustrated for each work step. In FIG. 17C, a style conversion reference image is illustrated. In FIG. 17B, an image obtained by converting styles of an image for each work step shown in FIG. 17A into styles of the reference image shown in FIG. 17C is illustrated.

In the conventional vector image technique shown in FIG. 8, it is impossible to perform style conversion from the first step, but in the present disclosure, as shown in FIGS. 17A to 17C, it may be confirmed that the style conversion may be performed throughout all the steps.

In addition, in the present disclosure, working environment information is sequentially stored together in vector information, and an actual working environment may be stored together in a vector line.

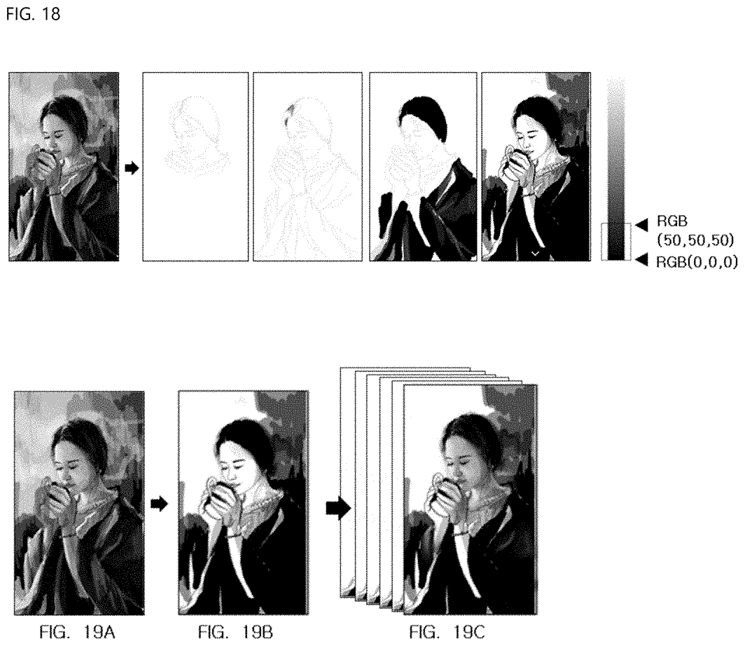

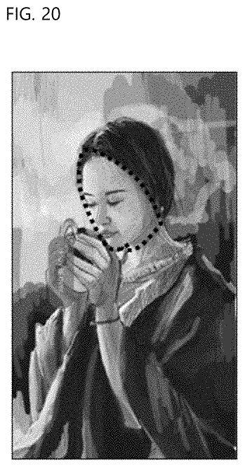

FIG. 18 is a view illustrating a process of selecting and replaying specific color regions in an image drawn in the vector method.

In FIG. 18, as an example applied to an actual vector picture, a process of selecting and first replaying a black color regions of RGB(0,0,0) to RGB(50,50,50) and not replaying the remaining strokes is illustrated.

FIGS. 19A to 19C are views illustrating a process of selecting and replaying a vector replay color sequence. FIG. 20 is a view illustrating a process of selecting and replaying an area.

In FIGS. 19A to 19C, states in which the black color regions from RGB(0,0,0) to RGB(50,50,50) are first selected, and then a face area is selected so as to select and replay an area corresponding to a face color later are respectively illustrated.

In FIG. 20, a state in which a user selects one or more color regions by drawing a polygon.

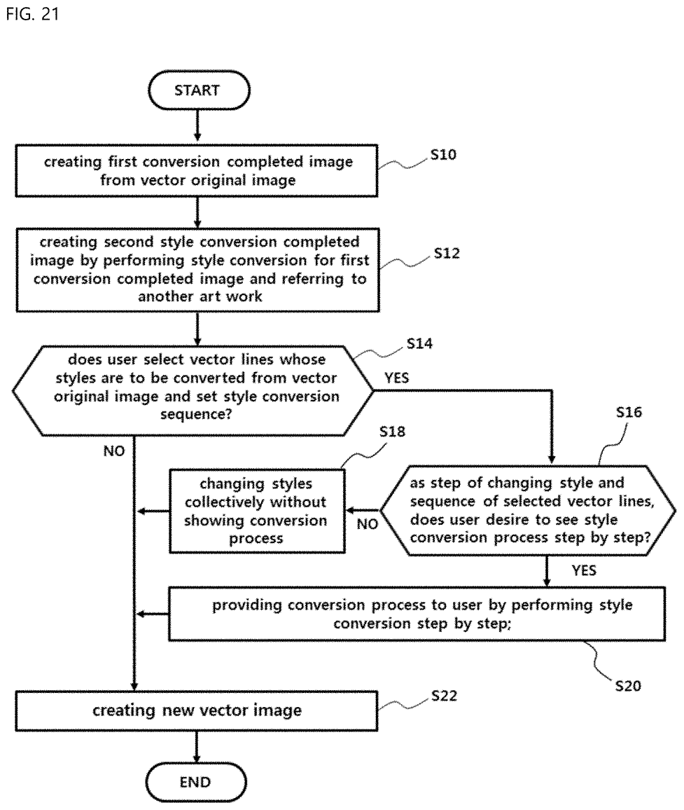

FIG. 21 is a flowchart describing step by step the method of converting and replaying styles of vector images according to the preferred exemplary embodiment of the present disclosure.

In step S10 of FIG. 21, a first original completed image is extracted and created from the vector original image in the final step or a user-selected work step.

In step S12, style conversion is performed for the first original completed image by referring to another art work, so as to create a second style conversion completed image.

In step S14, vector lines whose styles are to be converted are selected by a user from among the vector lines included in the vector original image, and whether a sequence of style conversion of the selected vector lines is set is checked.

As a result of the checking in step S14, in a case where the vector lines are selected and the sequence of style conversion is set, the styles and sequence of the selected vector lines are changed, and in step S16, it is checked whether the user desires to see the style conversion process step by step.

As a result of the checking in step S16, in a case where the user does not desire to see the style conversion process step by step, the style conversion process is not displayed in step S18, but the style conversion is performed collectively and proceeded to step S22 below.

Whereas, in a case where the user desires to see the style conversion process step by step as a result of the checking in step S16, the style conversion is performed step by step so that the conversion process is displayed step by step, thereby replaying the style conversion process by imitating a moving picture in step S20.

Meanwhile, as the result of the checking in step S14, when the vector lines are selected and the sequence of style conversion is not set, or when step S18 or S20 is performed, a new vector image is finally created in step S22 thereafter.

Through the processes as described above, as the styles are changed step by step for the vector lines selected by the user with respect to lines in the vector method, the embodiment of the present disclosure may replay the color conversion process by imitating a moving picture in real time, as if an artist were actually working.

That is, for the pictures and text in which the work process for images drawn in the vector method is saved, the embodiment of the present disclosure may match, one-to-one, a position of one stroke worked in the vector method and a color of a pixel position of a style-converted reference image and may receive, from a user, a selection of which the coordinate value of each stroke of the vector method should be reflected, so that the colors may be changed by referring to the selected coordinate values based on position information to be referred to and applying the colors of the style-converted image.

In addition, in the present disclosure, when all strokes are sequentially changed, the entire vector line is sequentially executed, and the accurate style conversion process may be appreciated as if a moving picture were replayed in real time.

In addition, in the present disclosure, in a case for extracting colors of the current vector line to be drawn from a style-converted line, when resolution of the image after style conversion and resolution of the original image before style conversion are the same, the coordinate values are identical, so the color may be easily extracted, and in a case of converting the resolution to another resolution, the color may be extracted by matching the coordinate values and calculating with a formula according to the converted resolution ratio.

In addition, in the present disclosure, since a general movie usually replays images of 24 to 25 frames per second, when 20 or more vector lines are replayed as much as possible per second, a smooth moving image may be replayed like a moving picture.

However, in the conventional bitmap method, since the time to perform style conversion for one picture usually depends on the resolution and quality and it takes about four to six seconds for the style conversion, it is not suitable for replaying a moving picture that requires 20 or more pictures per second.

Accordingly, the present disclosure may be utilized in various ways, such as picture appreciation or picture chatting.

As described above, the present disclosure that is realized by the present inventors has been described in detail according to the above exemplary embodiment, but the present disclosure is not limited to the above exemplary embodiment, and various modifications can be made without departing from the spirit of the present disclosure.

The present disclosure may be applied to technology for a method of converting styles of vector images and a method of replaying the vector images, wherein the styles of pictures and text in which the work process for images drawn in the vector method is saved are converted step by step as if a real artist were working and the playback sequence is changed and replayed according to the user's selection.

1. A method of converting and replaying styles of vector images, the method converting the styles of an original image in a vector method where vector line information is stored and a sequential work sequence stored for each work step of each vector line in which work of drawing an image including a picture and text is made is stored and comprising:
(a) extracting a first original completed image from a vector original image at a final step or at each work step selected by a user;
(b) converting styles of the first original completed image into styles of another art work to create a second style conversion completed image;
(c) receiving vector lines, whose styles are to be converted, selected from among vector lines included in the vector original image, and determining a sequence of style conversion of the selected vector lines;
(d) extracting coordinate values for each of the vector lines selected in step (c), generating line information from lines at the same position as those of coordinate values extracted from the second style conversion completed image, performing the style conversion by changing the vector line information included in the vector original image to generate the line information, and changing the sequence of the style conversion and style replay; and
(e) finally creating a new vector image by displaying step by step a style conversion process of the vector original image according to user's settings in step (d) and replaying the style conversion process by imitating a moving picture, or finally creating the new vector image by collectively changing the style conversion process without displaying the style conversion process.

2. The method of claim 1, wherein the vector line information comprises one or more pieces of information on a work sequence index of the vector lines, coordinate values stored in the lines, thicknesses of the lines, colors of the lines, shapes of the lines, types of pens used, types of brushes used, transparency of the lines, and pen pressure indicating the pressure of the pens.

3. The method of claim 1, wherein, in step (c), all the vector lines are selected when the vector lines are not selected by the user.

4. The method of claim 1, wherein, in step (c), the vector lines are selected, by the user, with one or more colors or color regions, and the style conversion is performed for the colors or the color regions of the selected vector lines.

5. The method of claim 1, wherein, in step (c), a region is selected by the user using one or more polygons, or the vector lines are selected in stroke units by using one or more selection lines and styles of the vector lines are converted.

6. The method of claim 4, wherein, in step (c), remaining vector lines excluding the vector lines selected by the user are inverted to be selected and styles of the remaining vector lines are converted.

7. The method of claim 1, wherein, in step (c), the sequence of the style conversion is set in an order in which the vector lines whose styles are to be converted are selected, or a sequence for each vector line is set by the user so as to perform the style conversion.

8. The method of claim 1, wherein, in step (d), colors corresponding to the coordinate values selected by the user is extracted from among current coordinate values of the vector lines whose styles are to be converted.

9. The method of claim 1, wherein, in step (d), colors for the extracted coordinate values are extracted and a unit for applying the extracted colors is applied to each coordinate value section, so as to perform the style conversion by dividing the coordinate values present in a line of the vector original image rather than by a unit of the line, or the style for each coordinate value unit is converted within one line rather than an entire line unit, the coordinate value unit being one section unit obtained by centers of adjacent coordinate values.

10. The method of claim 1, wherein, in step (d), colors for all coordinate values in the vector lines of the current work step are extracted from the second style conversion completed image, and the colors are extracted by calculating with any one filter value from among values of average, rounding off, and rounding down of all the extracted colors.

11. The method of claim 1, wherein, in step (d), each resolution of the vector original image, the first original completed image, and the second style conversion completed image of steps (a) and (b) is converted to be same and the coordinate values of the vector original image and the style conversion completed image are matched, so as to generate each piece of information, and when each resolution is converted differently, the coordinate values are matched by calculating according to the converted screen size ratio, so as to generate each piece of the information.

12. The method of claim 5, wherein, in step (c), remaining vector lines excluding the vector lines selected by the user are inverted to be selected and styles of the remaining vector lines are converted.
